(19) United States
(12) Patent Application Publication
(10) Pub. No.: US 2026/0149876 A1
(43) Pub. Date: May 28, 2026

(54) IMAGE PICKUP APPARATUS, IMAGING SYSTEM, CONTROL METHOD, AND STORAGE MEDIUM

(71) Applicant: CANON KABUSHIKI KAISHA, Tokyo (JP)

(72) Inventors: KEIICHIRO SAITO, Tokyo (JP); KEI TOHYAMA, Kanagawa (JP); YOSHIRO ICHIHARA, Kanagawa (JP); HIDEKI DOBASHI, Kanagawa (JP)

(21) Appl. No.: 19/353,902

(22) Filed: Oct. 9, 2025

(30) Foreign Application Priority Data
Nov. 22, 2024 (JP) 2024-204012

(51) Int. Cl. H04N 23/60; H04N 23/74; H04N 23/82

(52) U.S. Cl. CPC H04N 23/64; H04N 23/74; H04N 23/82

(57) ABSTRACT

An image pickup apparatus communicable with an illumination apparatus may include an image sensor configured to acquire a first raw image in each of a first state under illumination by the illumination apparatus and a second state under no illumination by the illumination apparatus, one or more memories storing instructions, and one or more processors that, upon execution of the instructions, operate to generate a second raw image by removing information on an imaging condition from the first raw image, perform combination processing using the second raw image, and generate a third raw image by adding the information to the second raw image that has received the combination processing.

### BACKGROUND

### Field of the Technology

The aspect of the disclosure relates to one or more embodiments of an image pickup apparatus, an imaging system, a control method, and a storage medium.

### DESCRIPTION OF THE RELATED ART

One of the conventional exposure simulation function for image pickup apparatuses simulates an imaging result before actual imaging so as to enable the user to check a reproduced image before imaging. However, this function has a problem in that the exposure simulation does not work properly in imaging in synchronization with an illumination apparatus that emits a flashlight because the illumination light is not constant light, and thus the imaging result is unknown until the actual imaging.

Japanese Patent Application Laid-Open No. 2007-281937 discloses an imaging system that calculates each light component based on images captured under a plurality of illumination units and ambient light and then combines an image. Japanese Patent Application Laid-Open Publication No. 2010-114600 discloses a camera system that continuously controls a plurality of illumination apparatuses in a series of sequences and saves an image with light emission at a ratio to constant light and an image without light emission.

The imaging system disclosed in Japanese Patent Application Laid-Open No. 2007-281937 performs conversion processing into a luminance-linear color space by applying an inverse function of the γ curve to a captured (developed) image. Thus, the processing time to complete the combination processing may increase due to the development processing time required for each developed image, and the image quality of the final combination result may be degraded in a case where an inverse function is applied to a lossy compressed developed image.

The camera system disclosed in Japanese Patent Application Laid-Open No. 2010-114600 processes developed images. Thus, the processing time to complete the combination processing may increase due to the development processing time required for each developed image, and combination of compressed color space may cause image quality degradation such as a luminance shift or a color shift.

### SUMMARY

An image pickup apparatus according to one or more aspects of the disclosure communicable with an illumination apparatus may include an image sensor configured to acquire a first raw image in each of a first state under illumination by the illumination apparatus and a second state under no illumination by the illumination apparatus, one or more memories storing instructions, and one or more processors that, upon execution of the instructions, operate to generate a second raw image by removing information on an imaging condition from the first raw image, perform combination processing using the second raw image, and generate a third raw image by adding the information to the second raw image that has received the combination processing. An imaging system having the above image pickup apparatus, a control method corresponding to the above image pickup apparatus, and a storage medium storing a program that causes a computer to execute the above control method also constitute another aspect of the disclosure.

Features of the disclosure will become apparent from the following description of embodiments with reference to the attached drawings. The following description of embodiments will be provided by way of example.

### BRIEF DESCRIPTION OF THE DRAWINGS

FIG. 1 is a block diagram of an imaging system according to a first embodiment.

FIG. 2 is a flowchart illustrating an imaging operation according to the first embodiment.

FIG. 3 is a flowchart illustrating combination processing according to each embodiment.

FIG. 4 is a conceptual diagram illustrating first to third raw images according to each embodiment.

FIG. 5 conceptually illustrates combination calculation according to the first embodiment.

FIG. 6 is a block diagram of an imaging system according to a second embodiment.

FIG. 7 is a flowchart illustrating an imaging operation according to the second embodiment.

FIG. 8 conceptually illustrates combination calculation according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### FIRST EMBODIMENT

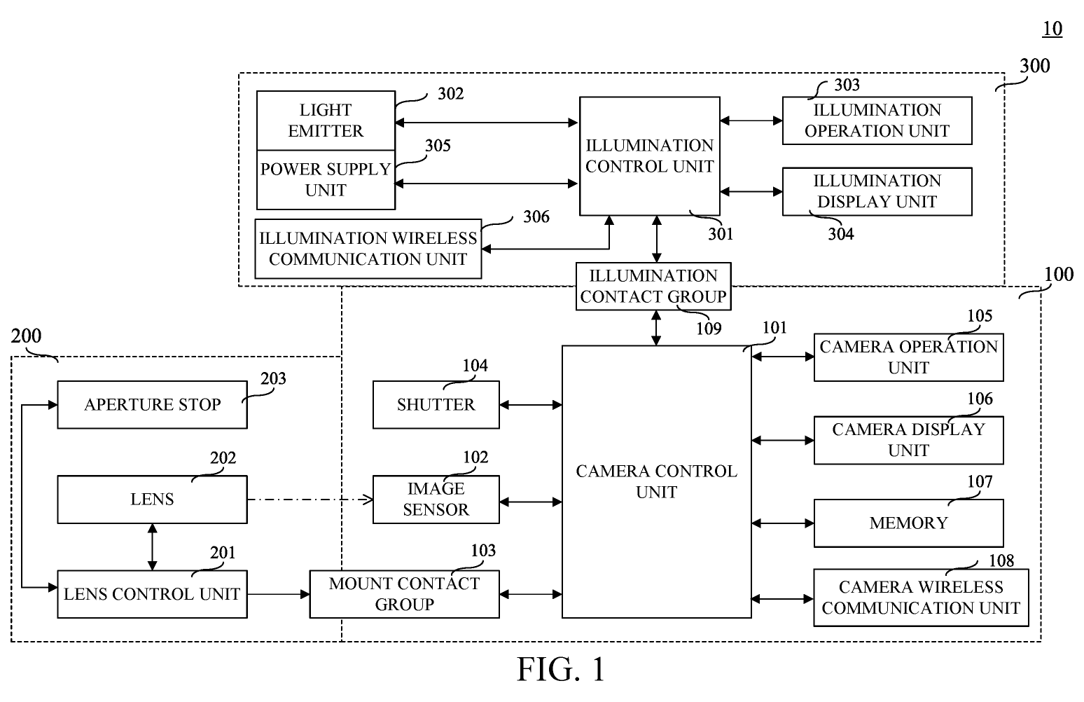

Referring now to FIG. 1, an imaging system 10 according to a first embodiment of the disclosure will be described. FIG. 1 is a block diagram of the imaging system 10. The imaging system 10 includes a camera body (image pickup apparatus) 100, a lens apparatus 200, and a flash apparatus (illumination apparatus, strobe apparatus) 300.

In this embodiment, the lens apparatus 200 is an interchangeable lens attachable to and detachable from the camera body 100, but this embodiment is applicable to an image pickup apparatus in which the lens apparatus and the camera body are integrated. In this embodiment, the flash apparatus 300 is used as the illumination apparatus, but another illumination apparatus such as an organic EL light or an LED light may also be used. In this embodiment, the flash apparatus 300 is attachable to and detachable from the camera body 100, but the flash apparatus 300 may be integrated with the camera body 100, or may be configured wirelessly connected to the camera body 100 without being mechanically connected to the camera body 100. That is, the camera body 100 may be communicable with the flash apparatus 300 (so that it can control the flash apparatus 300).

In FIG. 1, a lens apparatus 200 is attached to the front of the camera body 100. The lens apparatus 200 is interchangeable, and the camera body 100 and lens apparatus 200 are electrically connected via a mount contact group 103. The flash apparatus 300 is attached to the top of the camera body 100. The flash apparatus 300 is interchangeable, and the camera body 100 and flash apparatus 300 are electrically connected via an illumination contact group 109.

First, the configuration of the camera body 100 will be described. A camera control unit (one or more processors) 101 is a microcomputer that controls the operation of each part of the camera body 100. The camera control unit 101 also includes an internal memory (one or more memories) storing various adjustment values and programs (instructions) for executing a variety of controls. The internal memory also serves as a buffer memory for temporarily storing various data processed in various locations.

An image sensor 102 is a CMOS sensor or CCD sensor, etc., and converts light from an object that is incident through a lens (imaging optical system) 202 into an electrical signal, generates image signals including still and moving images, and outputs them to the camera control unit 101.

A focal plane shutter 104 is disposed between the image sensor 102 and the lens 202, and operates according to an instruction from the camera control unit 101. The focal plane shutter 104 includes a front curtain and a rear curtain, and exposure of the image sensor 102 starts when the front curtain moves and the shutter opens, and ends when the rear curtain moves and the shutter closes.

The camera operation unit (setting unit) 105 includes operation members that are operable by the user, and detects operations performed by the user via a button, a switch, a dial, a connected device, etc. attached to the camera body 100, and sends a signal according to the operation instruction to the camera control unit 101. The camera operation unit 105 outputs to the camera control unit 101 an instruction signal (SW1 signal) issued when the user half-presses a release button for still image capturing, and an instruction signal (SW2 signal) issued when the user fully presses the release button. For moving image capturing, it outputs an instruction signal (REC signal) issued when the user operates a record button to the camera control unit 101.

A camera display unit 106 displays imaging information and a captured image in accordance with an instruction from the camera control unit 101.

The camera control unit 101 controls the operation of the camera body 100 based on the output signal from the camera operation unit 105. In a case where the output signal from the camera operation unit 105 is an SW1 signal, it drives the image sensor 102 for imaging and outputs focus information such as a defocus amount for each focus point. It also detects a main object based on a captured image and repeats photometry (light metering) control (auto-exposure (AE) operation) to measure the luminance of the main object, and determines a shutter speed, aperture value (F-number), and ISO sensitivity (ISO speed) to be used during imaging based on the photometry result. Here, the shutter speed, aperture value, and ISO sensitivity to be used during imaging will be collectively referred to as an exposure control value. The user may manually set the exposure control value using the camera operation unit 105. The determined exposure control value is displayed on the screen of the camera display unit 106.

In a case where the output signal from the camera operation unit 105 is an SW2 signal, the camera control unit 101 drives the aperture stop 203 in the lens 202, sets the sensitivity (ISO sensitivity) of the image sensor 102, and controls the focal plane shutter 104 to irradiate light onto the image sensor 102. In a case where the output signal from the camera operation unit 105 is a REC signal, the camera control unit 101 sets the sensitivity (ISO sensitivity) and frame rate of the image sensor 102, drives the image sensor 102 for imaging, and outputs focus information such as the defocus amount for each focus point. The camera control unit 101 also detects a main object based on a captured image and irradiates light onto the image sensor 102 while repeating photometry control (AE operation) to measure the luminance of the main object.

A lens control unit 201, described below, drives a focus lens (not illustrated) for focusing within the lens 202 in accordance with an instruction from the camera control unit 101 to repeat autofocusing (AF). The camera control unit 101 displays a captured image on the screen of the camera display unit 106 in accordance with image data acquired from the image sensor 102, and controls the writing of image data (including sound information) to a memory (storage, one or more memories) 107.

A camera wireless communication unit 108 performs wireless communication between the camera body 100 and an external device, sending and receiving data such as image signals, audio signals, compressed image data, and compressed audio data. The camera wireless communication unit 108 also sends and receives control signals relating to imaging, such as commands to start and stop imaging, as well as other setting and operation command information. The camera wireless communication unit 108 is a wireless communication module, such as an infrared communication module, a Bluetooth (registered trademark) communication module, a wireless LAN communication module, or WirelessUSB.

The configuration of the lens apparatus 200 will now be described. The lens control unit 201 is a microcomputer that controls the operation of each component of the lens apparatus 200. The lens 202 includes a plurality of lenses and forms an object image on the image sensor 102. The lens 202 includes an aperture stop 203 for adjusting a light amount and a focus lens (not illustrated) for focusing. The lens control unit 201 adjusts the light amount taken into the camera and the focus in accordance with an instruction from the camera control unit 101 through control via the mount contact group 103, and sends distance information and other data obtained at that time to the camera control unit 101.

Next, the configuration of the flash apparatus 300 will be described. An illumination control unit 301 is a microcomputer that controls the operation of each component of the flash apparatus 300. The illumination control unit 301 can communicate with the camera control unit 101 via the illumination contact group 109, and can receive a light emission control instruction and camera information from the camera and transmit flash apparatus information. A light emitter 302 includes a light emission circuit and a light-emission optical system.

An illumination operation unit 303 has operation members operable by the user, detects an operation performed by the user via a button, a dial, etc. attached to the flash apparatus 300, and sends a signal corresponding to the operation instruction to the illumination control unit 301. An illumination display unit 304 displays a light emission mode and the like in accordance with an instruction from the illumination control unit 301. A power supply unit 305 supplies energy to generate illumination light to irradiate the object to be imaged, using power from a battery (not illustrated) installed in the flash apparatus 300. Information on the power supply (including the remaining battery capacity, etc.) is controlled by the illumination control unit 301 and sent to the camera control unit 101 via the illumination contact group 109.

In accordance with an instruction from the illumination control unit 301, the light emitter 302 drives the light emission circuit to emit light from the xenon tube, and irradiates the object at a predetermined illumination angle via the light-emission optical system. The light emission amount, illumination angle, etc. of the light emitter 302 may be set by the illumination operation unit 303, or may be acquired by communication from the camera control unit 101 via the illumination contact group 109 or the camera wireless communication unit 108 and illumination wireless communication unit 306. The illumination control unit 301 receives a control signal from the camera control unit 101 via the illumination contact group 109 and can cause the light emitter 302 to emit light at a predetermined light emission amount and illumination angle in conjunction with the imaging operation of the camera body 100. In the acquisition by communication from the camera control unit 101, automatic setting by the camera control unit 101 or setting by operation from the camera operation unit 105 is possible.

Like the camera wireless communication unit 108, an illumination wireless communication unit 306 performs wireless communication between the flash apparatus 300 and an external device (camera body 100), and sends and receives a variety of settings such as a light emission amount and an illumination angle, as well as an operation command. The illumination wireless communication unit 306 is, for example, a wireless communication module such as an infrared communication module, a Bluetooth (registered trademark) communication module, a wireless LAN communication module, or WirelessUSB.

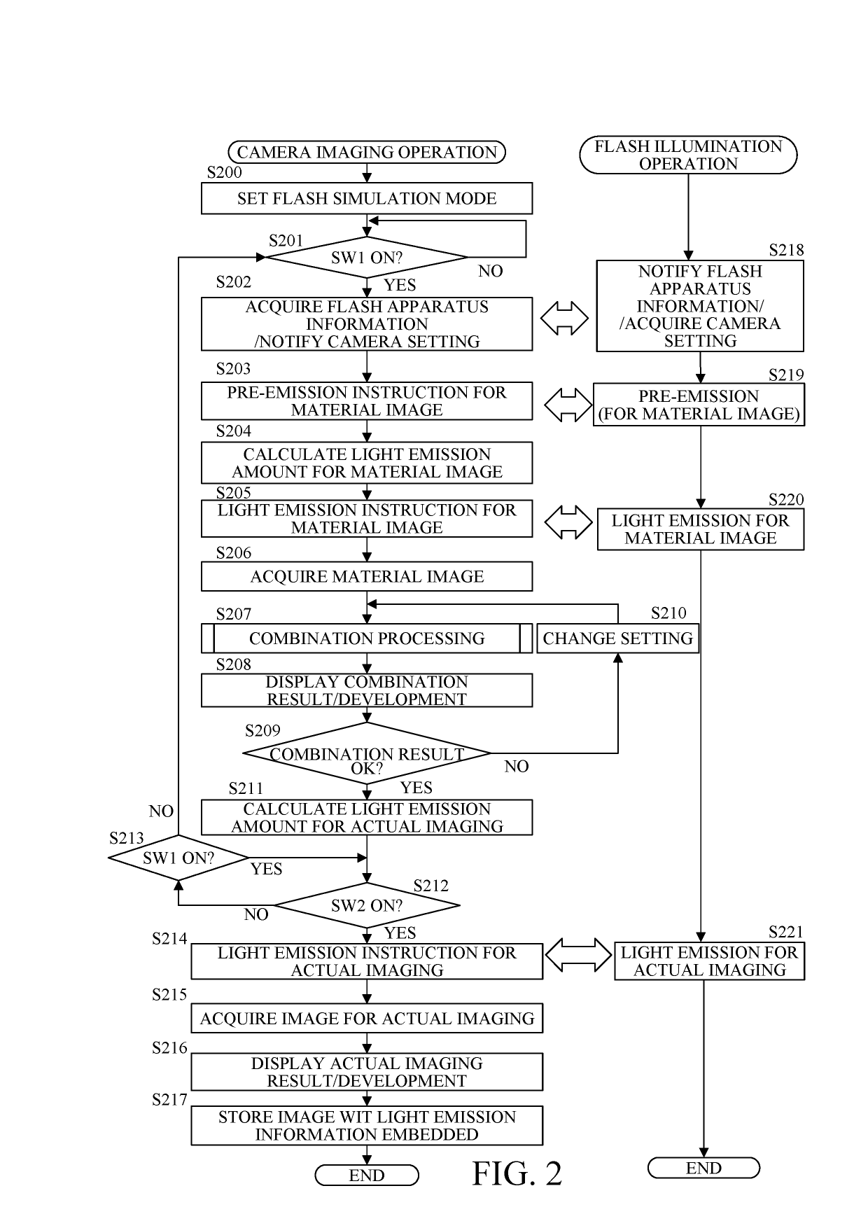

Referring now to FIG. 2, the operation (imaging operation) of the imaging system 10 according to this embodiment will be described. FIG. 2 is a flowchart illustrating an example of an imaging operation using the camera body 100 and the flash apparatus 300. In a case where the main power of the camera body 100 in the camera operation unit 105 is turned on, power is supplied from a battery (not illustrated) to each block in the camera body 100, initialization is performed, and a variety of settings are read. Thereby, an imaging operation is prepared. When the main power of the flash apparatus 300 in the illumination operation unit 303 is turned on, power is supplied from the power supply unit 305 to each block in the flash apparatus 300, initialization is performed, and a variety of settings are read. Thereby, an imaging operation is prepared. The flash apparatus 300 may be configured to receive power from the camera body 100 via the illumination contact group 109.

In step S200, the user operates the camera operation unit 105 in accordance with the mode selection screen displayed on the camera display unit 106 to select the flash simulation mode.

In step S201, the camera control unit 101 monitors the state of the SW1 signal and determines whether SW1 is turned on. In a case where it is determined that SW1 is turned on, the flow proceeds to step S202. In step S202, the camera control unit 101 notifies the flash apparatus 300 of the camera settings. In step S218, the illumination control unit 301 acquires various pieces of information about the flash apparatus 300 via the illumination contact group 109. The information acquired here includes information indicating the maximum light emission amount, illumination angle range, battery status, etc. of the flash apparatus 300.

In step S203, the camera control unit 101 issues a light emission instruction to the illumination control unit 301 via the illumination contact group 109 of the flash apparatus 300 to perform (flash) pre-emission (preliminary emission) for acquiring a material image. In step S219, the illumination control unit 301 controls the light emitter 302 based on the light emission instruction from the camera control unit 101 in step S203, and performs pre-emission for acquiring a material image to be used in the combination processing of the flash simulation.

In step S204, the camera control unit 101 acquires pre-emission information from the flash apparatus 300 in step S219 via the illumination contact group 109, and drives the image sensor 102 to expose with the pre-emission received from the lens apparatus 200. The camera control unit 101 then calculates a light emission amount of the light emitter 302 required in the next step S206.

In step S205, the camera control unit 101 issues a light emission instruction to the illumination control unit 301 via the illumination contact group 109 of the flash apparatus 300 to emit light for acquiring a material image at the light emission amount calculated in step S204. In step S220, the illumination control unit 301 controls the light emitter 302 based on the light emission instruction from the camera control unit 101 in step S205, and emits light to acquire a material image to be used in the flash simulation combination processing.

In step S206, the camera control unit 101 acquires the light emission information on the flash apparatus 300 in step S220 via the illumination contact group 109, and drives the image sensor 102 to expose the light incident from the lens apparatus 200. The camera control unit 101 drives the image sensor 102 and stores the acquired raw image (image data that records the output of the image sensor 102 as is) in the internal memory of the camera control unit 101. Hereinafter, the raw image acquired from the image sensor 102 will be referred to as the first raw image.

In step S206, the camera control unit 101 acquires two material images (first raw images). One of the material images is a non-flashed image (second image data acquired in a second state when the flash apparatus 300 does not emit flashlight), which may be acquired using an exposure control value manually set by the user, or alternatively, an AE image or the like. At this time, the lens control unit 201 performs AF by driving the focus lens (not illustrated) in the lens 202 in accordance with an instruction from the camera control unit 101 via the mount contact group 103.

The other material image is a flashed image (first image data acquired in a first state when the flash apparatus 300 emits flashlight) using the flash apparatus 300 described above. The flashed image has the same condition as that of the non-flashed image other than the presence or absence of flashlight emission (for example, an exposure control value such as the position of the focus lens (not illustrated) in the lens 202, shutter speed, aperture value, and ISO sensitivity). This is because, during the combination processing described below, it may cause a luminance shift, a color shift, or degradation in image resolution. Thus, the first raw image includes first image data acquired in the first state in which the flash apparatus 300 emits flashlight, and second image data acquired in the second state in which the flash apparatus 300 does not emit flashlight.

In step S207, the camera control unit 101 uses the first raw image stored in the internal memory of the camera control unit 101 in step S206 to perform combination processing for a flash simulation that displays an image obtained while the flash apparatus 300 emits flashlight. The combination processing will be described later.

In step S208, the camera control unit 101 applies a γ curve (a gamma curve) to the third raw image combined in step S207, and displays the result on the camera display unit 106. The camera control unit 101 may also apply a γ curve to a fourth raw image obtained by encoding (losslessly compressing) the third raw image, and display the result on the camera display unit 106. Alternatively, the camera control unit 101 may display an image obtained by developing the third raw image or the fourth raw image. The development processing to the combination result of step S207 rather than developing each material image obtained in step S206 can reduce the processing load, and reduce the overall processing time in the flash simulation.

In step S209, the user operates the camera operation unit 105 to confirm whether the flash simulation result displayed on the camera display unit 106 is the intended result. In a case where the intended result is obtained, the flow proceeds to step S211. On the other hand, in a case where it is different from the intended result and it is to be changed, the flow proceeds to step S210.

In step S210, the user operates the camera operation unit 105 to change the settings of the flash simulation result displayed on the camera display unit 106. The setting here is mainly used for flash adjustment (dimming correction) and affects the adjustment of the light emission amount of the flash apparatus 300. Once the setting is completed, the flow proceeds to step S207, where the combination processing is repeated for repeated fine adjustment until the user achieves the desired result.

In step S211, the camera control unit 101 calculates the light emission amount of the flash apparatus 300 for the actual imaging, based on the combination processing result determined in step S209.

In step S212, the camera control unit 101 monitors the state of the SW2 signal and determines whether SW2 is turned on. In a case where it is determined that SW2 is turned on, the flow proceeds to step S214. On the other hand, in a case where SW2 is turned off, the flow proceeds to step S213, and as long as SW1 is maintained turned on, the camera control unit 101 repeats monitoring step S212 until SW2 is turned on. In a case where SW1 is turned off in step S213, the flow proceeds to step S201.

In step S214, the camera control unit 101 issues a light emission instruction to the illumination control unit 301 via the illumination contact group 109 of the flash apparatus 300, so as to emit a flashlight for the actual imaging at the light emission amount calculated in step S211. In step S221, the illumination control unit 301 controls the light emitter 302 based on the light emission instruction from the camera control unit 101 in step S214 to emit a flashlight for the actual imaging.

In step S215, the camera control unit 101 acquires the light emission information on the flash apparatus 300 in step S221 via the illumination contact group 109, and drives the image sensor 102 for imaging processing and exposes the light from the lens apparatus 200. In the imaging processing, the exposure control value or the light emission amount of the light emitter 302 is controlled so that the captured image has the desired exposure by the user, as determined in step S209. The camera operation unit 105 may be configured to allow separate settings for acquiring the first raw image during combination processing and the first raw image during the actual imaging. The camera control unit 101 stores the first raw image for the actual imaging acquired by driving the image sensor 102 in its internal memory. After the imaging processing is completed, the flow proceeds to step S216.

In step S216, the camera control unit 101 applies a γ curve to the first raw image acquired from the image sensor 102 in step S215, and displays the result obtained on the camera display unit 106. Alternatively, the camera control unit 101 may apply a γ curve to a fifth raw image obtained by encoding (losslessly compressing) the first raw image, and display the obtained result on the camera display unit 106. The camera control unit 101 may display an image obtained by developing the first raw image or the fifth raw image.

In step S217, the camera control unit 101 saves the image developed in step S216 in the memory 107. At this time, information about the camera body 100, lens apparatus 200, and flash apparatus 300, etc., is embedded in the image. In addition to the developed image for the actual imaging, the first through fifth raw images, including the material images generated in the flash simulation mode sequence, and the display image may also be stored in the memory 107 (the second raw image will be described later). Furthermore, in order to reduce the usage of internal memory in the camera control unit 101, the first through fifth raw images and the display image may be restored from the internal memory of the camera control unit 101 to the memory 107 once each processing is completed in steps prior to step S217. After each image is stored, the series of imaging operations ends.

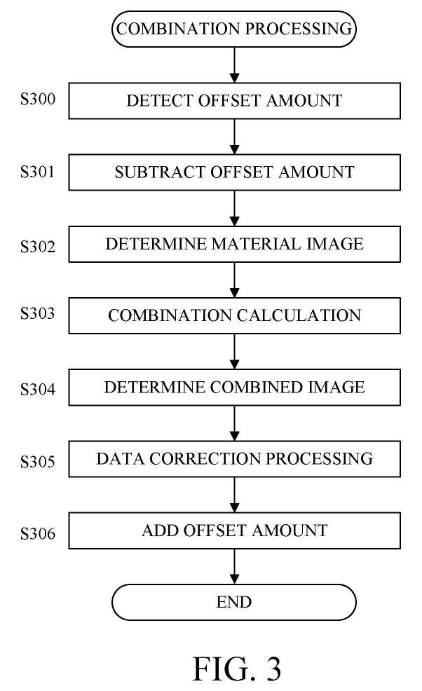

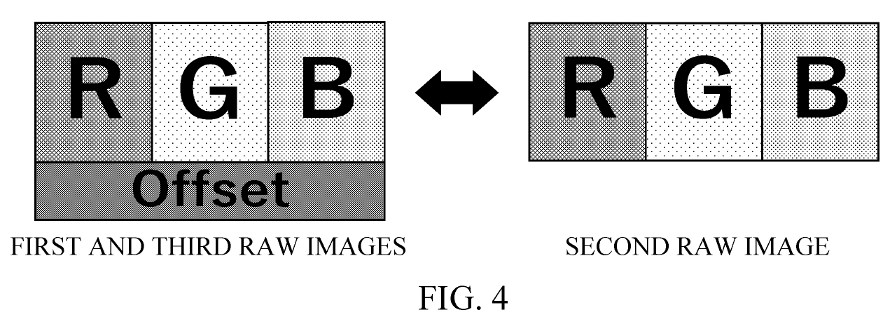

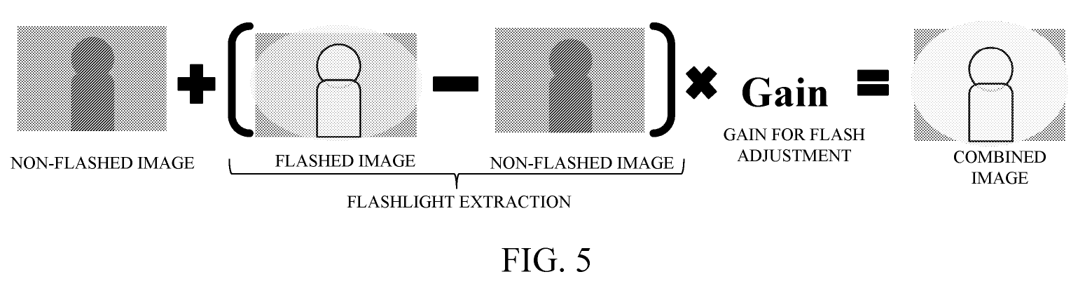

Referring now to FIGS. 3 to 5, a description will be given of the combination processing in step S207. FIG. 3 is a flowchart illustrating an example of the combination processing in step S207. FIG. 4 is a conceptual diagram illustrating the first through third raw images. FIG. 5 conceptually illustrates the combination calculation. In a case where the first raw image of the material image is stored in the internal memory in the camera control unit 101 in step S206, the camera control unit 101 starts the flowchart of FIG. 3.

In step S300, the camera control unit 101 detects an offset amount added to the first raw image of the material image acquired in step S206. The offset amount will now be described with reference to FIG. 4.

The first raw image obtained from the image sensor 102 as a model can be expressed as illustrated on the left of FIG. 4. The offset amount illustrated here corresponds to information on the imaging condition, and is added to the data of the first raw image. The offset amount is, for example, a value that changes for each image sensor 102, or a value that changes according to the setting, such as ISO sensitivity (imaging setting) (information on the image sensor and imaging setting). Therefore, if a plurality of images are directly combined using the first raw image, a deviation by the offset amount will occur from the desired RGB values, and the image output after the combination processing will suffer from image quality degradation, such as a luminance shift or a color shift.

Accordingly, this embodiment performs a combination calculation using a second raw image (the image on the right side of FIG. 4) obtained by temporarily removing the offset amount from the first raw image, and after the combination processing, the removed offset amount is added back to generate an image as a third raw image. Thereby, a luminance or color shift can be suppressed during the combination processing compared to a case where the offset amount is not removed.

The flowchart follows the above process from step S301 onwards. In step S301, the camera control unit 101 subtracts the offset amount detected in step S300 from the first raw image of each material image, generates a second raw image with the offset amount removed, and stores it in the internal memory of the camera control unit 101.

In step S302, the camera control unit 101 determines whether the color data of the stored second raw image of the material image falls within a predetermined threshold range (predetermined range). This is to prevent color misalignment, because the RGB relationship is disrupted in a case where an image with overexposure or crushed shadows, or an image with a similar exposure state is used as a material image for combination.

In a case where the color data falls outside the predetermined threshold range, the camera control unit 101 sets an alert flag and, when displaying the image on the camera display unit 106, displays an alert (alert processing), such as zebra display or highlight display, on the relevant image area. In step S302, a determination is made for the second raw image of each material image, but this embodiment is not limited to this example. The alert flag may be inherited along with alert range information for any of the first through fifth raw images, or may be performed each time for the first through fifth raw images, or an image displayed on the camera display unit 106 at an unillustrated timing. A predetermined object detection may be performed, and the alert determination processing may be changed according to the detection result of the main object. For example, if a person is detected as a main object, an alert may be set to only the area around the face, or in the case of a landscape, the alert range may be set to cover the entire sky. Methods using known technologies such as face detection, pupil detection, moving object detection, pattern matching, and distance mapping may be used to detect the predetermined main object.

Thus, the camera control unit 101 can perform alert processing if at least one of the first raw image, second raw image, third raw image, fourth raw image, and fifth raw image contains data outside the predetermined range. Alternatively, the camera control unit 101 may perform correction processing if at least one of the first to fifth raw images contains data that falls outside the predetermined range.

In step S303, the camera control unit 101 performs the combination calculation using the second raw image of each material image and stores the result in the internal memory of the camera control unit 101.

The combination calculation will now be described with reference to FIG. 5. In this embodiment, flashlight is extracted by subtracting the non-flashed image (fourth image data) from the flashed image (third image data). Next, a gain corresponding to a necessary flash adjustment amount is applied based on a light emission amount when the flashed image was captured (gain processing is performed). This reproduces what would happen if the light emission amount were actually changed by flash adjustment. Then, the adjusted flashlight component is added to the non-flashed image, and the result of the actual imaging can be simulated.

Thus, in this embodiment, the second raw image includes third image data generated by subtracting the offset amount from the first image data, and fourth image data generated by subtracting the offset amount from the second image data. The camera control unit 101 performs combination processing using the second image data and data obtained by performing gain processing for a difference between the third image data and the fourth image data. The camera control unit 101 may perform gain processing during the combination processing based on the light emission amount for each individual or group of flash apparatuses 300.

While this embodiment uses a single flash apparatus 300 in this method, this method can acquire flashed images for the number of flash apparatuses 300 (or groups of flash apparatuses) and one non-flashed image as a material image in step S206. This embodiment enables the user of the flash apparatus 300 to find a proper light emission amount setting without repeating the actual imaging each time.

Unless the user has set it in advance, the default flash simulation setting may be one that results in proper exposure of the main object after the combination calculation. In other words, in an imaging system using a plurality of flash apparatuses 300, the default setting may be set to a setting in which a light emission amount is adjusted according to the number of flash apparatuses and how the flashlight from each flash apparatus 300 hits the main object.

In this embodiment, the camera control unit 101 may acquire the first raw image through a light emission instruction at a light emission amount that is proper for the object. The camera control unit 101 may instruct the light emission amount of the flash apparatus 300 so as to prevent at least one of the first to fifth raw images from becoming data that falls outside the predetermined range, perform gain processing according to the proper light amount for the object during the combination processing, and generate the third raw image.

In step S304, the camera control unit 101 determines whether the color data of the second raw image that has received the combination calculation falls outside the predetermined threshold range. In a case where this determination has already been made in step S302, this determination may be omitted. In a case where the alert flag is set, the camera control unit 101 may alert the camera display unit 106 in accordance with the alert flag.

In step S305, the camera control unit 101 performs data correction processing for the second raw image that has received the combination calculation. This is because the RGB relationship is disrupted in a case where an image with overexposure or crushed shadows, or an image with a similar exposure state, is used as a material image for combination. For example, if the material image is in a state close to overexposure, the combined image appears pink.

Accordingly, in the case of the overexposure example, data complement processing may be performed so that the relevant area is displayed in white, or blurring processing, like a white gradation, may be performed. Alternatively, according to the above predetermined object detection result, the user may be able to select whether to issue an alert in step S302 or S304 in a case where the complement range is a person, or to perform only a white complement in step S305 for the background sky.

In step S306, the camera control unit 101 adds the offset amount removed in step S301 to the second raw image that has received the combination calculation, generates the third raw image with the offset amount added, and stores it in the internal memory of the camera control unit 101 or in the memory 107. The flowchart of FIG. 3 then ends, and the flow proceeds to step S208.

Thus, this embodiment performs the combination processing using linear raw image data that has not received the γ curve, suppresses a luminance shift, a color shift, or image quality degradation that may occur during the combination processing, and obtains a combination processing result that is close to the actual imaging result. This embodiment stores the first raw image in the internal memory of the camera control unit 101 and performs the combination processing of FIG. 3, but is not limited to this example. Rather than storing the material image in the internal memory of the camera control unit 101 in the form of the first raw image, the material image may be encoded into the fifth raw image and then stored. In this case, the fifth raw image may be decoded and restored to the state of the first raw image before the combination processing of FIG. 3, and then the combination processing of FIG. 3 may be performed. Thereby, the encoding processing and decoding processing are necessary, but the internal memory capacity of the camera control unit 101 can be reduced.

This embodiment performs the various processing associated with the imaging operations of the camera body 100, lens apparatus 200, and flash apparatus 300. This embodiment performs the combination processing using the first to third raw images of the material image, suppresses a luminance shift, a color shift, or image quality degradation that may occur during the combination processing, and acquires a combination processing result close to an actual capture result.

The flowcharts described in this embodiment are merely illustrative, and various processing may be performed in a different order from that of the flowcharts described in this embodiment.

### SECOND EMBODIMENT

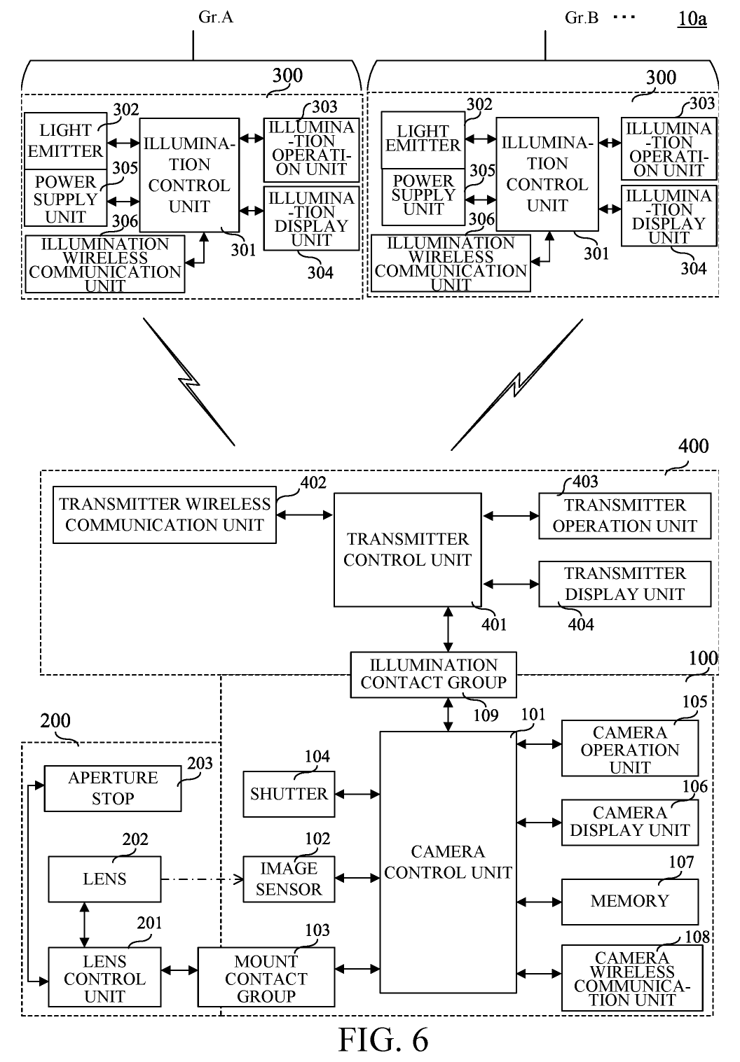

Referring now to FIG. 6, an operation (imaging operation) of an imaging system 10a according to a second embodiment of the disclosure will be described. FIG. 6 is a block diagram of the imaging system 10a. The imaging system 10a includes a camera body (image pickup apparatus) 100, a lens apparatus 200, a flash apparatus (illumination apparatus) 300, and a transmitter (transmission apparatus) 400.

FIG. 6 illustrates a state in which the flash apparatus 300 of FIG. 1 is removed from the illumination contact group 109 of the camera body 100, and the transmitter 400 is attached to the illumination contact group 109 instead. FIG. 6 also illustrates a state in which a transmitter wireless communication unit 402 of the transmitter 400 and the illumination wireless communication unit 306 of each flash apparatus 300 are wirelessly connected. In this embodiment, a plurality of flash apparatuses 300 are wirelessly connected to the transmitter 400, and can be individually controlled by changing the wireless communication group setting.

This embodiment differs from the first embodiment in that the flash apparatuses 300 are not physically connected to the camera body 100, and constitute an imaging system as independent illumination apparatuses. This embodiment also differs from the first embodiment in that the imaging system includes a plurality of flash apparatuses 300 via wireless communication. This embodiment will discuss an example in which the transmitter 400 is wirelessly connected to the plurality of flash apparatuses 300, but can use the camera wireless communication unit 108 of the camera body 100 for wireless connection to the plurality of flash apparatuses 300 without using the transmitter 400.

In FIG. 6, the camera body 100, lens apparatus 200, and flash apparatuses 300 other than the transmitter 400 are the same as those in the first embodiment, and thus a description thereof will be omitted.

A transmitter control unit 401 is a microcomputer that controls the operation of each component in the transmitter 400. The transmitter control unit 401 can communicate with the camera control unit 101 via the illumination contact group 109, and can receive a light emission control instruction and camera information from the camera body 100 to the flash apparatus 300, and can transmit flash apparatus information.

The transmitter wireless communication unit 402, similarly to the camera wireless communication unit 108 and the illumination wireless communication unit 306, performs wireless communication between the transmitter 400 and an external device (camera body 100 or flash apparatus 300). The transmitter wireless communication unit 402 transmits and receives a variety of settings, such as a light emission amount and an illumination angle, as well as an operation command. The transmitter wireless communication unit 402 is, for example, a wireless communication module such as an infrared communication module, a Bluetooth (registered trademark) communication module, a wireless LAN communication module, or WirelessUSB.

A transmitter operation unit 403 has operation members operable by the user, detects an operation performed by the user via a button, a dial, etc. attached to the transmitter 400, and sends a signal corresponding to the operation instruction to the transmitter control unit 401. A transmitter display unit 404 displays a light emission mode and other information in accordance with an instruction from the transmitter control unit 401. The transmitter 400 has no power supply unit such as a battery, but is configured to be powered by receiving power from the camera body 100 via the illumination contact group 109.

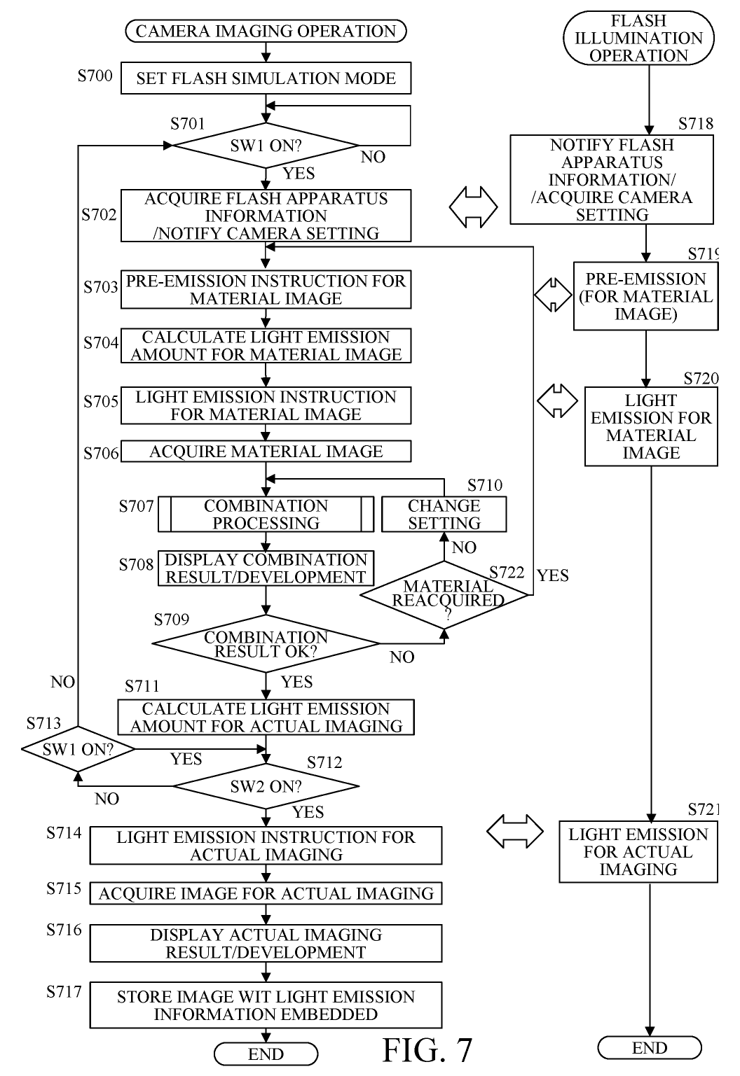

Referring now to FIG. 7, a description will be given of the operation (imaging operation) of the imaging system 10a. FIG. 7 is a flowchart illustrating an example of an imaging operation using the camera body 100 and the flash apparatuses 300. In FIG. 7, a description of parts corresponding to the operations in steps S200 to S221 in FIG. 2 will be omitted.

In step S701, the camera control unit 101 monitors the state of the SW1 signal and determines whether SW1 is turned on. In a case where it is determined that SW1 is turned on, the flow proceeds to step S702. In step S702, the camera control unit 101 notifies the flash apparatus 300 of the camera setting via wireless communication from the transmitter 400 via the illumination wireless communication unit 306 and the transmitter wireless communication unit 402. In step S718, the illumination control unit 301 of each of the plurality of flash apparatuses 300 wirelessly acquires various information from the transmitter 400 via the illumination wireless communication unit 306 and the transmitter wireless communication unit 402. The information acquired here includes information indicating a maximum light emission amount, an illumination angle range, and a battery status of the flash apparatus 300, the number of wirelessly connected flash apparatuses 300, a light emission preparation state, a light emission group, ID, a channel setting, etc.

In step S703, the camera control unit 101 issues a light emission instruction to the illumination control unit 301 in each of the plurality of flash apparatuses 300 via the transmitter 400 to perform a pre-emission for acquiring a material image. In step S719, the illumination control unit 301 in each of the plurality of flash apparatuses 300 controls the light emitter 302 based on the light emission instruction from the camera control unit 101 in step S703, and performs the pre-emission for acquiring the material image to be used for the flash simulation combination processing.

In step S704, the camera control unit 101 acquires pre-flash information for each of the plurality of flash apparatuses 300 in step S719 via the transmitter 400. The camera control unit 101 also drives the image sensor 102 to expose it with the pre-flash received from the lens apparatus 200, and calculates the light emission amount of the light emitter 302 required in the next step S706.

In step S705, the camera control unit 101 issues a light emission instruction to the illumination control unit 301 of each of the plurality of flash apparatuses 300 via the transmitter 400 so that the light emission for acquiring the material image is performed at the light emission amount calculated in step S704. In step S720, the illumination control unit 301 of each of the plurality of flash apparatuses 300 controls the light emitter 302 based on the light emission instruction from the camera control unit 101 in step S705, and emits light for acquiring the material image to be used in the flash simulation combination processing.

In step S706, the camera control unit 101 acquires the light emission information on each of the plurality of flash apparatuses 300 in step S720 via the transmitter 400, and drives the image sensor 102 to expose it with the light from the lens apparatus 200. The camera control unit 101 stores in its internal memory, the acquired first raw image acquired by driving the image sensor 102.

In steps S706 and S720, adjustments may be made to suppress overexposure in a flashed image of a material image, to acquire the material image that is easy to combine in step S707, and to prevent the reacquisition of the material image, as described below. For example, adjustments may be made to control a light emission amount of each flash apparatus 300 for slight underexposure and to acquire the material image. In addition, exposure control for flash simulation mode may be performed, for example, by increasing the shutter speed to suppress object blur and lowering the ISO sensitivity to suppress noise.

In this embodiment, in step S706, the camera control unit 101 acquires material images equal to the number of wireless groups of flash apparatuses 300 wirelessly connected to the transmitter 400, in addition to the non-flashed image. In a case where light emission control is performed not for each wireless group but for each individual flash apparatus 300, material images equal to the number of wirelessly connected flash apparatuses 300 are acquired, in addition to the non-flashed image.

In step S709, the user operates the camera operation unit 105 to check whether the flash simulation result displayed on the camera display unit 106 is the intended result. In a case where the intended result is obtained, the flow proceeds to step S711. On the other hand, in a case where it is different from the intended result and it is to be changed, the flow proceeds to step S722.

In step S722, the user operates the camera operation unit 105 to select whether or not to reacquire material images. In a case where the material images are to be reacquired, the flow proceeds to step S704. On the other hand, in a case where the material images are not to be reacquired and only a setting is to be changed, the flow proceeds to step S710. In a case where the material images acquired in step S706 include images that fall outside the range of a predetermined threshold, such as overexposure or crushed shadows, automatic determination processing may be performed to automatically reacquire the material images. In reacquiring material images, even if each flash apparatus 300 is caused to emit a flashlight at a light emission amount close to that used before reacquisition, it is highly likely that the intended result by the user is not achieved. Thus, for example, if overexposure occurs before reacquisition, the light emission amount of the flash apparatus 300 used for that material image may be reduced by two steps; if crushed shadows occur before reacquisition, the light emission amount of the flash apparatus 300 used for that material image may be increased by two steps. Thus, changes may be made so that the reacquired material images fall within the predetermined threshold range.

In step S710, the user operates the camera operation unit 105 to change the setting of the flash simulation result displayed on the camera display unit 106. The setting change is performed for all flash apparatuses 300 wirelessly connected via the transmitter 400, and the setting change may be made for the flash apparatus 300 or the wireless group to be changed to the intended result by the user. Once the setting is completed, the flow proceeds to step S707, where the combination processing is repeated for repeated fine adjustment until the user achieves the desired result.

In step S711, the camera control unit 101 calculates the light emission amount of each flash apparatus 300 for the actual imaging based on the combination processing result determined in step S709.

In step S714, the camera control unit 101 issues a light emission instruction to the illumination control unit 301 of each of the plurality of flash apparatuses 300 via the transmitter 400, so that the light is emitted for the actual imaging at the light emission amount calculated in step S711. In step S721, the illumination control unit 301 of each of the plurality of flash apparatuses 300 controls the light emitter 302 based on the light emission instruction from the camera control unit 101 in step S714, and emits a flashlight for the actual imaging.

In step S715, the camera control unit 101 acquires the light emission information on each of the plurality of flash apparatuses 300 acquired in step S721 via the transmitter 400, and drives the image sensor 102 to perform imaging processing and exposes it with the light incident from the lens apparatus 200. In the imaging processing, the exposure control value or the light emission amount by the light emitter 302 is controlled so that the captured image has the desired exposure by the user, as determined in step S709. The camera control unit 101 stores the first raw image of the actual imaging acquired by driving the image sensor 102, in the internal memory of the camera control unit 101. After the imaging processing is completed, the flow proceeds to step S716.

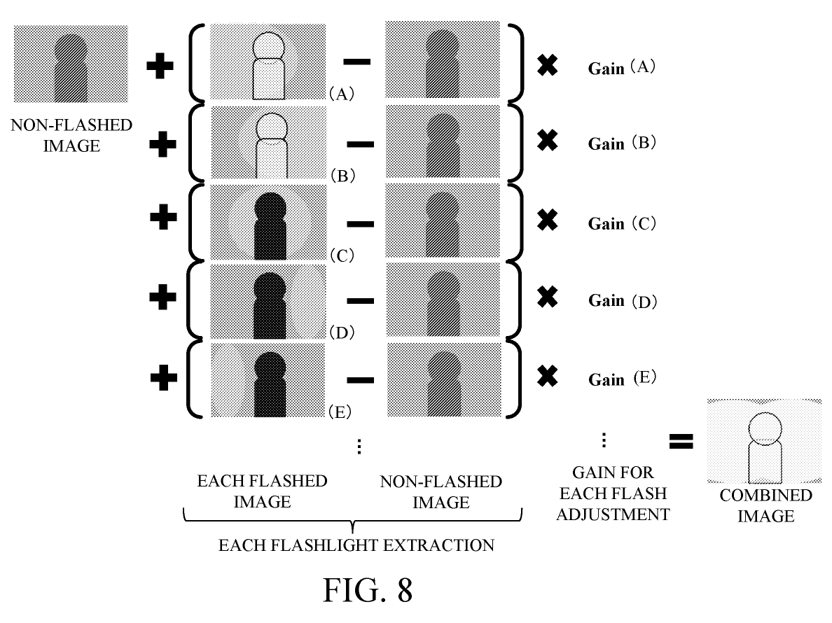

Finally, with reference to FIG. 8, a description will be given of the combination calculation in a case where there are a plurality of flash apparatuses 300. FIG. 8 conceptually illustrates the combination calculation according to this embodiment. This embodiment differs from the first embodiment in that the flashlight is extracted from each of multiple wirelessly connected flash apparatuses 300 and a gain corresponding to the required flash adjustment amount is applied based on the light emission amount when each flashed image was captured. The actual imaging result can then be simulated by adding each adjusted flashlight light component to the non-flashed image. This method acquires a flashed image for each flash apparatus 300 (or for each wireless group to be emitted) and one non-flashed image as material images in step S206. This method enables the user of the flash apparatus 300 to find a proper light emission amount setting without repeating actual imaging each time.

As described above, this embodiment executes various processing associated with the imaging operations of the camera body 100, lens apparatus 200, flash apparatus 300, and transmitter 400. In multi-light imaging using a plurality of flash apparatuses, this embodiment performs combination processing using first to third raw images of the material images, suppresses a luminance shift, a color shift, or image quality degradation that may occur in the combination processing, and obtains a combination processing result that is close to an imaging result obtained in the actual imaging. The flowcharts described in this embodiment are merely illustrative, and various processing may be executed in an order different from that of the flowcharts described in this embodiment.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

For example, instead of the camera body 100 as the image pickup apparatus, a smartphone with a camera function that can be wirelessly connected to the flash apparatus 300, a head-mounted display with a built-in camera, etc., may be used. Instead of the flash apparatus 300, another illumination apparatus, such as an LED light or an organic EL light, may be used.

Each embodiment according to the disclosure can provide an image pickup apparatus that can suppress image quality degradation that occurs during image combination processing.

This application claims the benefit of Japanese Patent Application No. 2024-204012, which was filed on November 22, 2024, hereby incorporated by reference herein in its entirety.

What is claimed is:

1. An image pickup apparatus communicable with an illumination apparatus, the image pickup apparatus comprising:
an image sensor configured to acquire a first raw image in each of a first state under illumination by the illumination apparatus and a second state under no illumination by the illumination apparatus;
one or more memories storing instructions; and
one or more processors that, upon execution of the instructions, operate to:
generate a second raw image by removing information on an imaging condition from the first raw image,
perform combination processing using the second raw image, and
generate a third raw image by adding the information to the second raw image that has received the combination processing.

2. The image pickup apparatus according to claim 1, wherein the information on the imaging condition includes information on the image sensor and an imaging setting.

3. The image pickup apparatus according to claim 1, wherein the first raw image includes first image data acquired under the illumination by the illumination apparatus and second image data acquired under no illumination by the illumination apparatus,
wherein the second raw image includes third image data generated by removing the information from the first image data, and fourth image data generated by removing the information from the second image, and
wherein the one or more processors operate to perform the combination processing using the second image data and data obtained by applying gain processing to a difference between the third image data and the fourth image data.

4. The image pickup apparatus according to claim 1, wherein the one or more memories store the third raw image.

5. The image pickup apparatus according to claim 4, wherein the one or more memories configured to store at least one of the first raw image, the second raw image, a fourth raw image obtained by losslessly compressing the third raw image, and a fifth raw image obtained by losslessly compressing the first raw image.

6. The image pickup apparatus according to claim 5, further comprising a display unit configured to display an image obtained by applying a γ curve to the third raw image or the fourth raw image.

7. The image pickup apparatus according to claim 5, wherein the one or more processors operate to perform alert processing in a case where at least one of the first raw image, the second raw image, the third raw image, the fourth raw image, and the fifth raw image includes data that falls outside a predetermined range.

8. The image pickup apparatus according to claim 5, wherein the one or more processors operate to perform correction processing in a case where at least one of the first raw image, the second raw image, the third raw image, the fourth raw image, and the fifth raw image includes data that falls outside a predetermined range.

9. The image pickup apparatus according to claim 5, wherein the one or more processors operate to:
instruct a light emission amount of the illumination apparatus so that at least one of the first raw image, the second raw image, the third raw image, the fourth raw image, and the fifth raw image does not fall outside a predetermined range, and
perform gain processing according to a proper light amount for an object during the combination processing to generate the third raw image.

10. The image pickup apparatus according to claim 1, further comprising a setting unit configured to individually set a setting for acquiring the first raw image during the combination processing and a setting for acquiring the first raw image during actual imaging.

11. The image pickup apparatus according to claim 1, wherein the one or more processors operate to perform gain processing during the combination processing based on a light emission amount for each illumination apparatus or a group of illumination apparatuses.

12. The image pickup apparatus according to claim 1, wherein the one or more processors operate to:
instruct light emission at a proper light amount for an object, and
acquire the first raw image using the image sensor.

13. The image pickup apparatus according to claim 1, wherein in a case where the first raw image acquired in the first state includes data that falls outside a predetermined range, or in a case where the first raw image is an image different from intent of a user, the one or more processors operate to reacquire the first raw image.

14. The image pickup apparatus according to claim 1, wherein the one or more processors operate to set a setting for an actual imaging based on a setting that was used when the first raw image for the combination processing was acquired.

15. The image pickup apparatus according to claim 1, wherein the one or more processors operate to change alert determination processing according to an object detection result.

16. An imaging system comprising:
an illumination apparatus; and
an image pickup apparatus communicating with the illumination apparatus,
wherein the image pickup apparatus includes:
an image sensor configured to acquire a first raw image in each of a first state under illumination by the illumination apparatus and a second state under no illumination by the illumination apparatus;
one or more memories storing instructions; and
one or more processors that, upon execution of the instructions, operate to:
generate a second raw image by removing information on an imaging condition from the first raw image,
perform combination processing using the second raw image, and
generate a third raw image by adding the information to the second raw image that has received the combination processing.

17. A control method for an image pickup apparatus communicable with an illumination apparatus, the control method comprising:
acquiring, using an image sensor, a first raw image in each of a first state under illumination by the illumination apparatus and a second state under no illumination by the illumination apparatus;
generating a second raw image by removing information on an imaging condition from the first raw image,
performing combination processing using the second raw image, and
generating a third raw image by adding the information to the second raw image that has received the combination processing.

18. A non-transitory computer-readable storage medium storing a program that causes a computer to execute the control method according to claim 17.
